(19) United States
(12) Patent Application Publication
(10) Pub. No.: US 2001/0016226 A1
(43) Pub. Date: Aug. 23, 2001

(54) Method for preparing the surface of a dielectric

(75) Inventors: Wesley Natzle, New Paltz, NY (US); Peter R. Duncombe, Peekskill, NY (US); Rajarao Jammy, Wappingers Falls, NY (US); David E. Kotecki, Orono, ME (US); Robert B. Laibowitz, Cortlandt Manor, NY (US); Chienfan Yu, Highland Mills, NY (US)

Correspondence Address: International Business Machines Corporation, 2070 Route 52, Hopewell Junction, NY, 12533, US

(73) Assignee: International Business Machines Corporation, Armonk, NY (US)

(21) Appl. No.: 09/824,385

(22) Filed: Apr. 2, 2001

Related U.S. Application Data
(63) Continuation of application No. 09/464,508, filed on Dec. 15, 1999.

(51) Int. Cl. B05D 5/12; B05D 3/04

(52) U.S. Cl. 427/79; 427/337

(57) ABSTRACT

This invention relates to a method for improving the chemical and electrical performance characteristics of a dielectric material especially one with high dielectric constant. The method comprises the steps of first obtaining a high dielectric constant material, the material having a degraded upper surface reduced dielectric constant and then modifying the surface chemistry of said upper surface by reacting said upper surface with a reactant. The reaction enables removal of the degraded layer. In a variant of the method, the gas reactant preferentially reacting with upper surface as compared to the bulk.

### FIELD OF THE INVENTION

The present invention relates to dielectric capacitors and gate dielectrics especially high dielectric capacitors and gate dielectrics which are useful in semiconductor devices. More particularly, the present invention relates to a method for producing high quality capacitors, as well as the structure of such capacitors.

### BACKGROUND OF INVENTION

Materials having a permittivity of at least 20 are important for use in capacitors for advanced DRAMs such as the 1 Gbit generation and beyond and for use as gate dielectrics for advanced Field Effect Transistors. However, it has not been easy to maximize the overall storage charge of capacitors containing high dielectric constant materials. Events that occur during the fabrication process can reduce the final overall charge storage capability of the capacitor, or produce variations in FET threshold voltages.

Capacitor performance can be increased by reducing the capacitor leakage current. Leakage current is a stray current which flows across the surface of a high dielectric constant capacitor or alternatively through the capacitor.

Leakage currents can cause unpredictable and detrimental changes in circuit conditions. It is therefore advantageous to reduce leakage currents in circuits. Thermal cycling is one way to reduce leakage currents. In thermal cycling, the high dielectric constant capacitor is heated to a critical temperature either before or after the overlying metallic layer is applied. Thermal cycling can also lead to increased adherence of the overlying metallic layer.

Additionally, new high dielectric constant material are being actively sought for the next generation of DRAM capacitors. Perovskites are an important class of high dielectric constant materials. Perovskites can be ferroelectrics and have a crystalline structure. Members of the perovskite family include BaTiO₃, SrTiO₃, LiNbO₃ and (Ba,Sr)TiO₃. (Ba,Sr)TiO₃ is a titanate that contains a mixture of barium, Ba, and strontium, Sr, and is also known as BST.

Overall storage capacity or FET threshold voltages and drive currents can be effected in different ways. Interfacial layers or degraded surface layers between the high dielectric layer and the electrodes can reduce the effective capacitive potential of a high dielectric constant material. There are a number of ways that a detrimental interfacial layer could be formed. The interfacial layer could be produced by a reaction of an underlying electrode with the process chemistry during the deposition of the high dielectric layer. Such an interface is buried and cannot be easily improved. Another type of detrimental interface could be caused by the presence of extraneous material on the topmost surface of the dielectric. It is important to note in the discussion which follows, that only a very small thickness of an extraneous layer of low dielectric constant is required at the interface to produce a detrimental impact on capacitance of a capacitor made from high dielectric constant materials.

The control of capacitance across an interfacial area between two electrodes is important because the interfacial area contributes to series capacitance. The total capacitance of the area between the two electrodes is given by the equation C=ε₀εᵣA/d; where ε₀ is the permittivity of free space, εᵣ is the relative permittivity of the dielectric material, A is the area and d is the separation between electrodes. When an interfacial area consists of more than one layer, the different layers all contribute to the overall capacitance.

When the dielectric constants of the layers comprising the interfacial area between two electrodes are not equal, each layer contributes to the determination of εᵣ, the relative permittivity of the high dielectric constant material. The variable εᵣ is related to the relative permittivities and thicknesses of the layers between the two electrodes and is represented by the equation: 1/(εᵣ/d)=1/(εᵣ₁/d₁)+1/(εᵣ₂/d₂.) Therefore it is desirable to maximize the dielectric constant for each layer since each layer contributes to the overall dielectric constant of the interfacial area. Thus a 2 Angstrom layer with a permittivity of 2 will cut the capacitance in half of a 200 Angstrom layer with permittivity of 200. Even a monolayer of contaminant is important.

One way to reduce interfacial interference at a surface is to clean the surface prior to electrode introduction. Many different methods exist to clean semi conductor component materials. Wet and dry pre-electrode deposition cleaning methods are known in the art but tend to be material specific. While pre-electrode cleaning solutions and methods do exist for other materials, there is no teaching of a method of increasing the overall performance of a high dielectric constant material that substantially modifies only the surface of a constituent material.

The most common examples of pre-electrode cleaning involve cleans required to ensure electrical connection between a deposited electrode and an underlying metal or semiconductor electrodes. In these cleans an oxide is the extraneous layer to be removed. The extraneous layer is completely removed, and a variable amount of overetch is acceptable. Cleaning of a gate dielectric or capacitor dielectric is much more-difficult. The reasons for the difficulty are described below for conventional silicon dioxide/silicon nitride capacitors and are described, for high dielectric constant materials, in the section discussing 5609927 to Summerfelt et. al.

Consider the cleaning of conventional low dielectric constant DRAM capacitor dielectrics or gate dielectrics composed of silicon dioxide silicon nitride or a combination. For instance, DRAM capacitor dielectrics commonly use a deposited layer of silicon nitride which is reoxidized to form a less leaky composite layer, but one which unfortunately has a lower effective dielectric constant because of the degraded dielectric constant of silicon dioxide relative to pure silicon nitride. Removal of any extraneous materials with a composition differing from the underlying composite would improve the dielectric performance. However, the use of a prior art etch which removes some of the dielectric (even unintentionally) is inconceivable when the leakage is dominated by tunnelling current through very thin films because leakage current increases exponentially with any small variations in thickness. Prior art etches lack sufficient control and uniformity. Furthermore, the thermal oxidation process which is typically used to form the silicon dioxide surface forms the best possible surface. There is no teaching of a method of increasing the overall performance of a low or high dielectric constant material that substantially modifies only a surface layer which contains a constituent of the underlying bulk.

Another type of treatment of high dielectric constant Perovskites discussed in the prior art is oxygen annealing. Oxygen annealing improves the material by replacing oxygen atoms that are depleted from the bulk material. These treatments add a material, oxygen, to a degraded dielectric. They do not teach removal of any constituents of the dielectric and do not teach removal of dielectric with degraded dielectric constant. They do not teach a preferential interaction with the surface layer or interface of the dielectric.

Summerfelt et al., U.S. Pat. No. 5,609,927, identifies yet another type of cleaning. In Summerfelt, hydroxides and carbonates are removed from the surface of a high dielectric constant layer by UV light exposure in an oxygen atmosphere and by reactive ion etch (RIE) plasma exposures. Unfortunately, it is well known that exposure to UV light and bombardment by ions can damage gate dielectrics. UV light can stimulate formation of trapped charge at the semiconductor/dielectric interface or at impurities within or on the surface of the dielectric. Ion bombardment can disrupt the structure of a material, can add unwanted materials implanted from the complex species within the plasma and can implant charged ions or electrons into the underlying material to form trapped electrical charges. Any charge remaining (and also variation in the amount remaining) after the treatment causes undesired device effects such as variation in charge stored at a given voltage in a capacitor or variation in threshold voltages of a transistor using the dielectric. Implanted impurities can serve as centers for increased leakage, and therefore reduced reliability. The high dielectric constant of many materials is critically dependent upon the structure, so although improvement may arise from the removal of hydroxides and carbonates from the surface, structural degradation from ion bombardment would still be expected to reduce the dielectric constant of the surface layer relative to the bulk. Furthermore, Summerfelt does not teach the use of a reaction which reacts selectively or preferentially with the surface of the dielectric. Summerfelt teaches the etching of 50 to 100 of the dielectric layer with a non-selective, non-reactive oxygen/argon ion bombardment, or reactive plasma Cl₂ chemistry. The removal entails far more than the removal of surface impurities. Control of the amount etched can cause problems since capacitance or threshold voltages are also dependent upon the thickness of the dielectric. Summerfelt requires in part the physical activation caused by energetic photons (not a chemical species) or bombardment by ions with energies created by the plasma which are far above (higher) than those available thermally. The ions sputter away reaction products, damage the surface to render it more reactive, and can travel so fast that an otherwise low reactivity species is rendered highly reactive.

Thus there remains a need for improved performance of a high dielectric constant capacitive materials such that the overall performance of the material is maximized, the surface layer containing a bulk constituent material is affected, and the leakage current is reduced. A method which automatically/preferentially etches impurities at only the surface is needed. A purely chemical method is needed which does not employ ionizing UV radiation or energetic charged particles (such as from a plasma). In particular, we shall show improved performance when a degraded surface layer which can result from the deposition process is removed by a method which is purely chemical and therefore minimizes the danger of producing any additional trapped charges within or on the surface of the dielectric.

### SUMMARY OF THE INVENTION

It is therefore an object of the present invention to provide a surface preparation method for dielectric capacitive materials, especially those with high dielectric constant.

It is a further object of the invention to provide a cleaning method that does not materially affect the characteristics of a barium containing constituent material beneath the surface layer of the barium containing high dielectric constant material.

It is another objective of the invention to provide a method for altering the surface chemistry of a high dielectric capacitive material without materially affecting the chemistry of the bulk constituent.

It is yet another objective of this invention to provide a method of maximizing the overall capacitance of a dielectric material, especially a high dielectric constant material.

It is still another object of the invention to create a(Ba,Sr)Tio₃ surface that is more conducive to electrode deposition.

It still yet another an objective of the invention to employ a chemistry reactive with the surface layer but not reactive with the bulk constituent of the high dielectric constant capacitive material.

It is an additional objective of the invention to perform a purely chemical alteration of the high dielectric constant material such that the danger of trapping any additional charge within or on the surface of the material is minimized.

The above listed and other objects are achieved by providing a method of forming dielectric capacitors comprising the steps of first forming on an underlying electrode, layers of bulk dielectric material the topmost of which has a degraded surface layer which contains at least one bulk constituent but which has a composition which degrades the overall dielectric constant, then a reaction is carried out which enables removal of the degraded surface layer.

### BRIEF DESCRIPTION OF THE DRAWINGS

These and other features, aspects, and advantages will be more readily apparent and better understood from the following detailed description of the invention, in which:

FIG. 1 is a cross-sectional view of the high dielectric constant material, including the underlying structures.

FIG. 2 is a cross-sectional view of a nitride/oxide dielectric with silicon dioxide etch back.

### DETAILED DESCRIPTION OF THE INVENTION

The present invention sets forth a technique for maximizing the performance of capacitors, the capacitors initially containing dielectric materials with a surface layer with a lower dielectric constant or which promotes leakage. In particular, the present invention provides a technique for producing capacitors having permittivities in the tens or hundreds by using materials with permittivity, greater than 20. The capacitors can be used in DRAM cells or as gate dielectrics in field effect transistors. The instant invention utilizes a purely chemical reaction that requires exposure to a reactive chemical species, usually uncharged and sometimes at an elevated temperature. However, a purely chemical reaction does not require the surface activation that is caused by simultaneous exposure to UV light or energetic ions. The ambient temperature of the wafer and gas above it is the only source of energy at the surface which is available to drive a purely chemical reaction.

The present invention has found that the dielectric constant of a capacitive material can be improved if the dielectric material is treated before deposition of overlying layers. Specifically, the present invention treats the surface of the high dielectric constant material before applying the overlying metallic layer. This treatment is such as to remove any unwanted oxides on the surface and/or to modify the surface of the dielectric to improve the performance.

The method of the invention can also reduce leakage currents in high permittivity material. The method of the present invention also effectively modifies the interfacial surface of a high dielectric constant capacitor without materially affecting the consistency or properties of the substrate as a whole.

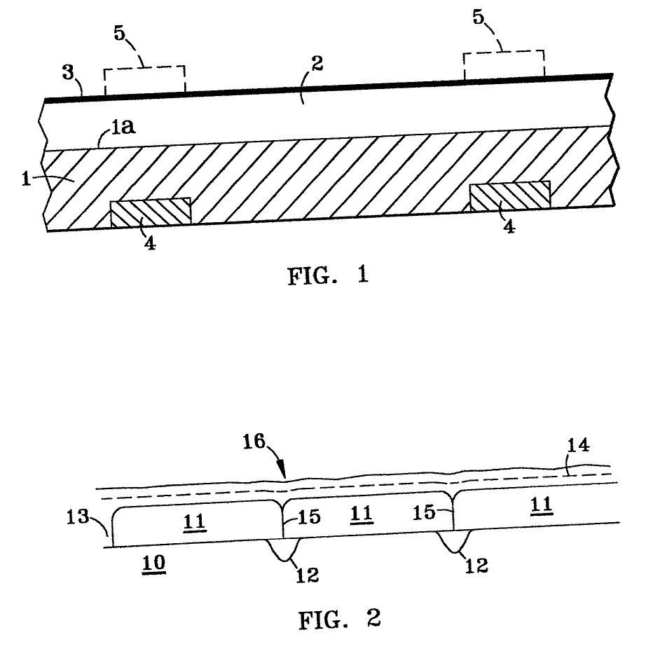

In the present invention, shown in FIG. 1, the constituent layer (Ba,Sr)TiO₃ is a first layer, 2, and the surface of the constituent (Ba,Sr)TiO₃, 3, is a second layer. The surface must be considered a second layer because the chemical and electrical characteristics of the surface are markedly dissimilar to the constituent material. The surface layer, 3, can be composed of material of atomic composition other than Ba, Sr, Ti, and O, or can be composed of Ba, Sr, Ti and O but with a composition different than the underlying material. Alternatively, the surface layer can have the same composition as the underlying (Ba,Sr)TiO₃ but have an undesired atom on the surface. In order to increase the overall dielectric constant it is therefore necessary to maximize the dielectric constant of both the first and second layer.

The present invention teaches a process whereby a dielectric surface treatment is performed on the high dielectric constant material prior to depositing subsequent layers on the high dielectric constant material. A dielectric surface treatment can consist of a single dielectric surface cleaning step. In a dielectric surface cleaning step, a gas reactant is introduced into a reactor containing the untreated capacitive material. The gas reactant is allowed to interact chemically with the surface of the high dielectric constant capacitive material and the gas is then extracted from the reactor.

The increase in the capacitance of the (Ba,Sr)TiO₃ layer, 3, is shown in Table 2 below. The increases shown are significant.

TABLE 1

| | | Ba + | Ba + |
|---|---|---|---|
| | | Surface | Constituent |
| Sample | Treated | 6 | 15 |
| 1 | Control | 19 | 22 |
| Sample | Treated | 6 | 16 |
| 2 | Control | 20 | 24 |
| Sample | Treated | 8 | 12 |
| 3 | Control | 20 | 20 |
| Sample | Treated | 8 | 15 |
| 4 | Control | 19 | 19 |

Ellipsometric measurements show that the layer thickness is increased slightly after treatment incorporated with the reactants, thus rendering the surface soluble in a subsequent rinse. Elements of the reactants are incorporated into the surface layer, increasing the layer thickness. After rinsing, at most 3-15 Angstroms of the original (pre-treatment) layer are removed from the surface of the high dielectric constant material. Repeated cycles of treatment/rinse show little or no thickness change. The bulk constituent material is substantially unaffected by the treatment.

The capacitance increase is greater than can be explained by simply a 3-15 Angstrom reduction in dielectric thickness. The increase comes from an improvement of dielectric constant in the surface layer.

Water rinsing, without the gaseous treatment, does not change the thickness of the dielectric layer.

The surface barium is effected by the dielectric surface treatment, as shown in Table 1. The concentration of surface barium is reduced. The data was accumulated using a number of diagnostic tools, including Auger analysis.

TABLE 2

| | No Treatment | After Treatment |
|---|---|---|
| | C/A | C/A |
| | avg/ | avg/ |
| | max | max |
| Sample 1 | 42/ | 48/ |
| | 45 | 51 |
| Sample 2 | 14/ | 23/ |
| | 16 | 25 |
| Sample 3 | 37/ | 48/ |
| | 39 | 59 |

As shown by table 1, the bulk constituent barium was substantially uneffected by the dielectric surface treatment while there was approximately a 30% reduction in the concentration of surface barium. Repeated treatments show that the surface was preferentially etched, thus eliminating the need to carefully time the etch. Apparently, the deposition process produces an imperfect or non-stochiometric layer of the surface. The above data defines a key discovery. A set of deposition conditions which produces an optimized bulk dielectric does not necessarily produce an optimized surface.

Furthermore, the way to optimize the overall composite is to react with the surface and remove some of the surface. This is in marked contrast to the prior art where the thin layers required with a conventional, low dielectric constant, silicon dioxide/or silicon nitride dielectric make surface preparation by an etching material removal step difficult or impossible when using conventional aqueous etches. The use of a high dielectric constant material enables a thicker dielectric so that any small thickness variation induced by the surface etch is a small fraction of the total dielectric thickness.

An important feature of our invention is that a gas is used to react with the surface layer. Although it is possible to carry out the invention with a liquid solution, the use of a gas enables a reaction that is preferred over a similar reaction in solution. For instance, if HF in solution is employed to remove the surface layer of BST, then reaction and dissolution takes place in a single step. Since the bulk (Ba,Sr)TiO₃ is soluble in a HF solution, it is difficult to react with just the surface layer. When gaseous HF, instead of a solution, is employed in the dielectric surface treatment, the reaction step can be carried out without dissolution. A second step, with water and no dissolved HF, can be employed to carry out dissolution of the reacted layer without significant additional reaction. The surface layer, 3 in FIG. 1, which is to be improved, is attacked and removed without substantial attack or removal of the underlying, constituent material.

In a preferred embodiment, shown in FIG. 1, a (Ba,Sr)TiO₃ layer, 2, is deposited on an upper surface, la of a substrate, Pt, layer, 1 on a wafer. The substrate, Pt, was deposited after the creation underlying electrodes, 4. According to the invention, the etchant and process of the present invention are viable whether the BST layer is patterned or not.

In this case the BST surface is deposited by chemical vapor deposition. The surface to be etched is an upper surface of the barium containing high dielectric constant material and is shown as, 3, in FIG. 1. The wafer containing the surface to be etched is introduced into a reactor capable of supplying a gas reactant. A dielectric surface cleaning step is then performed. In a preferred embodiment, a dielectric surface treatment consists of at least one dielectric surface cleaning step. In a more preferred embodiment the dielectric surface cleaning step is then followed by a rinse and dried using a drying means. In a most preferred embodiment, the dielectric surface treatment consists of a dielectric surface cleaning step/rinse/drying followed by a second dielectric surface cleaning step/rinse/drying.

The drying means can consist of any drying method known in the art. In a preferred embodiment, the drying means is a spin dry, a blow dry or a combination thereof. In a preferred embodiment, the gas reactant is HF. In a more preferred embodiment the gas reactant is a mixture of HF and NH₃. The gas reactant can be introduced into the chamber in a number of ways. The source could be separate gaseous sources of HF and NH₃. Alternatively, the gas reactant could be in the form of a plasma discharge in precursor gases that decompose to produce appropriate levels of HF and NH₃. For example, NF₃ and H₂ produce HF and NH₃. The discharge could be in the same chamber but would preferably be upstream of the chamber so that only neutral, uncharged molecules are in contact with the substrate.

In a most preferred embodiment, the dielectric surface treatment consists of a flow of gas sublimed from solid NH₅F₂, introduced into the reactor at 10 m Torr for about 1 minute. The NH₅F₂ vapor would be in the proportion of about two parts HF and about one part NH₃. A rinse containing deionized H₂O is then performed and the wafer is spun dry.

In an even more preferred embodiment the dielectric surface treatment is performed twice. The high dielectric constant material is then heated to 275 C. thereby reducing current leakage and promoting increased adherence. An overlying metallic layer, 5, is then deposited while the temperature is elevated.

An example of process conditions is given here to illustrate potential process parameters. Other configurations are possible and would be obvious to one skilled in the art and the use of alternative configurations not shown in the example would violate the scope and the spirit of the process.

### EXAMPLE

The wafer would be subjected to the following steps: 1) The BST wafer would be placed in a reactor; 2) The flow of HF and NH₃ would be introduced into the reactor upstream from the BST wafer; 3)The wafer would be exposed to HF and NH₃ for a time between 2 minutes 20 seconds and 40 minutes and the reactor would have a temperature set at 23 C. and a pressure of 10 mTorr; 4)The wafer would then be rinsed with deionized water at 23 C. for 2 minutes; 5) The wafer would then be spun dry. Steps 1-5 would be repeated a second time.

In alternative embodiments of the invention, high dielectric constant materials such as titanium, tantalum oxides or bismuth can be deposited or a dielectric surface treatment can be used to either introduce a non-constituent element to the surface only of the high dielectric constant material which enhances the functioning of the high dielectric constant material or remove non-bulk contaminants from the surface of the high dielectric constant material. When a non-constituent element is being introduced, after treatment the surface will have a second constitution which will comprise at least the constitution prior to cleaning (a first constitution) and the introduced element. The method can also be used to remove non-bulk contaminants from the surface of the high dielectric constant material.

A key observation in the previous treatment is that the an as-deposited film high dielectric film is not optimized for maximum capacitance without the invented etch. It turns out that “low dielectric” films that are optimized for low leakage by deposition of a silicon nitride layer followed by reoxidation are also not optimized for high capacitance. Once again the topmost silicon dioxide layer has a lower dielectric constant relative to silicon nitride. The presence of the silicon dioxide degrades the overall capacitance of the composite layer.

In yet another embodiment an etchback of the topmost silicon dioxide layer can improve the overall capacitance of the composite layer without seriously compromising the leakage of the film. Consider FIG. 2, where a silicon nitride film, 11, has been formed on silicon substrate, 10. The silicon nitride film can grow as islands which eventually grow together to form a single film. Such a film, comprised of small grains may give rise to fissures or gaps in the fine grains at locations, 15. Alternatively, fissures in the film can be formed by thermally induced cracks in the silicon nitride layer and under other circumstances. Current leakage of the film can be reduced if the film is reoxidized to form a silicon dioxide layer, 13. Since silicon dioxide occupies more volume than silicon nitride, the fissures or gaps, 15, will be partially filled by the reoxidation process. The filling of the original depression depth contributes to the lower leakage current following reoxidation, because there will be less tunnelling current due to a greater distance between electrode and underlying silicon. In situations where oxidation occurs along the boundaries of two or more fine grains, as represented in 16 and 17, the electrical leakage path is effectively sealed. Furthermore, in locations where the fissure extends all the way to the silicon substrate, the reoxidation will oxidize the underlying silicon substrate at locations, 12, thus protecting it from contact with the electrode. It is important to note that a clean, or etch, of the silicon dioxide film to form a new surface, 14, will not reopen the fissures.

The combination of reoxidation followed by etch back of the silicon dioxide layer partially decouples the preparation of the leakage characteristics of the film from the preparation of the capacitance/thickness of the film. For instance if the initial nitride thickness is greater than shown in FIG. B, the fissures, 15 will be nonexistent or have greater thickness but with a reduction of capacitance. The capacitance can then be recovered by a thicker than normal reoxidation followed by etching back the reoxidized layer. The final film will have improved capacitance/leakage.

There are additional reasons to remove part of the reoxidized layer. Due to subsequent thermal processing, the presence of dissimilar materials in the composite dielectric layer, silicon dioxide and silicon nitride, results in additional stresses which may generate electrical leakage paths. Therefore, to minimize the thermal and volumetric expansion mismatch, it is beneficial to have the thinnest possible reoxidized layer. To accomplish this, using the technique described in this invention, part of the initial reoxidized layer can be removed.

The same gaseous HF and ammonia mixture is an ideal etchant for this application for two reasons. 1) The low pressure operation of the reaction has greater uniformity than an aqueous reaction, and 2) the solid reaction product from this reaction plugs and further reduces the reaction rate in the bottom of any fissures which may not be completely filled by the reoxidation process. These etch properties open the option of a reoxidation/etch back process in these very thin “low dielectric” films where a conventional etch risks increasing tunnelling currents caused by a non-uniform final thickness.

An example of process conditions is given here to illustrate potential process parameters; other configurations are possible. A wafer with a reoxidized layer of about 15 and a nitride layer of about 40 would be placed in a reactor and subjected to the following steps so that preferably about 5 of the oxide layer is removed:

1) introducing HF and NH₃ upstream from the wafer in a two to one ratio;

2) exposing the wafer to wafer to the flow for, preferably, about 40 seconds at, preferably 5 mTorr, and at preferably, 23 C.;

3) heat the wafer to a temperature sufficient to evaporate a solid reaction product which forms when silicon dioxide reacts with the gasses, preferably to a temperature of about 100 C. for about 10 minutes.

During steps 1 and 2, elements of the reactants are added to the surface region as the silicon dioxide reacts. The reaction products are then removed during step 3 to leave behind a composite with higher effective dielectric constant.

Other embodiments include a non-aqueous solvent that could be used to clean/rinse the surface. It is also important to note that the invention does not preclude the use of a reactive ion etch plasma or a UV light treatments in other processing steps. In fact, the degraded surface caused by such treatments might be removed by the instant invention. The invention uses a chemical process. There are no ions or charged particles involved, so charges are not trapped with or on the surface of the treated object. The instant invention may aid in the removal of trapped charges introduced by prior processing. It should also be obvious that an oxide/nitride embodiment of the invention, such as the one previously described, could also be combined with other embodiments and inventions.

While the invention has been described in terms of specific embodiments, it is evident in view of the foregoing description that numerous alternatives, modifications and variations will be apparent to those skilled in the art. Thus, the invention is intended to encompass all such alternatives, modifications and variations which fall within the scope and spirit of the invention and the appended claims.

What is claimed:

1. A method of chemically treating he surface of an object to affect the dielectric constant, comprising:
(a) interacting an object having a first, upper surface and a bulk portion and a first constitution with a gaseous chemical compound, wherein the first surface is modified such that the dielectric constant of the first surface is increased.

2. The method of claim 1 wherein the gas reactant interacts preferentially with said upper surface compared to the bulk.

3. The method of claim 1 further comprising the steps of first rinsing said upper surface and then drying said upper surface using a drying means following the step of interacting said upper surface with said gas reactant in a closed environment.

4. The method of claim 3 further comprising the steps of interacting said upper surface with a gas reactant in a closed environment a second time followed by the steps of rinsing said upper surface a second time and then using a drying means to dry said upper surface a second time.

5. The method of claim 3 wherein said rinsing uses deionized H₂O and said drying means is one of a blow dry, a spin dry and a combination thereof.

6. The method of claim 4 wherein said first rinsing uses deionized H₂O and said first drying means is one of a blow dry, a spin dry and a combination thereof; and
said second rinse uses deionized H₂O, and said second drying means is one of a blow dry, a spin dry and a combination thereof.

7. The method of claim 1 wherein said gas reactant comprises HF.

8. The method of claim 1 wherein said gas reactant comprises a mixture of HF and NH₃.

9. The method of claim 1 further comprising the step of heating the high dielectric constant material to at least 275 C. after interacting said upper surface with a gas reactant in a closed environment.

10. A method of chemically introducing non-constituent elements to the surface of an object to increase the dielectric constant comprising:
a) interacting an object having a first surface, a bulk portion, the first surface and the bulk having a first constitution, with a chemical compound comprising at least one element that is not a constituent of the first surface, wherein the first surface is modified such that the first surface has a second constitution, the second constitution comprising the first constitution and the at least one element.

11. The method of claim 10 wherein said chemical compound is gaseous.

12. The method of claim 11 further comprising the steps of first rinsing said upper surface and then drying said upper surface using a drying means following the step of interacting said upper surface with said gas reactant in a closed environment.

13. The method of claim 12 further comprising the steps of interacting said upper surface with a gas reactant in a closed environment a second time followed by the steps of rinsing said upper surface a second time and then using a drying means to dry said upper surface a second time.

14. The method of claim 12 wherein said rinsing uses a deionized H₂O and said drying means is one of a blow dry, a spin dry and a combination thereof.

15. The method of claim 13 wherein said first rinsing uses deionized H₂O and said first drying means is one of a blow dry, a spin dry and a combination thereof; and said second rinse uses deionized H₂O, and said second drying means is one of a blow dry, a spin dry and a combination thereof.

16. The method of claim 11 wherein said gaseous reactant comprises HF.

17. The method of claim 11 wherein said gas reactant comprises a mixture of HF and NH₃.

18. The method of claim 10 further comprising the step of heating the high dielectric constant material to at least 275 C. after interacting said upper surface with a gas reactant in a closed environment.

19. The method of claim 10 further comprising the removal of the second constitution.

20. the method of claim 10 wherein the gaseous chemical compound interacts preferentially with said upper surface compared to the bulk.

21. the method of claims 10 wherein said bulk has a dielectric constant of at least about 20.

22. the method of claims 21 wherein the first constitution comprises a perovskite structure.

23. the method of claim 22 where the perovskite structure comprises a composition having at least one member selected from the group consisting of barium, strontium and bismuth and at least one member selected from the group consisting of titanates, tantalates and niobates.

24. A method of introducing non-constituent elements to the surface of an object, comprising:
a) interacting an object having a first surface and a bulk portion, the first surface having a first constitution and the bulk portion having a second constitution, with a chemical compound comprising at least one element that is not a constituent of one of the first surface or the bulk portion, wherein the first surface is modified such that the first surface has a third constitution, the third constitution comprising the at least one element.

25. The method of claim 24 wherein said chemical compound is gaseous.

26. The method of claim 25 further comprising the steps of first rinsing said upper surface and then drying said upper surface using a drying means following the step of interacting said upper surface with said gas reactant in a closed environment.

27. The method of claim 26 further comprising the steps of interacting said upper surface with a gas reactant in a closed environment a second time followed by the steps of rinsing said upper surface a second time and then using a drying means to dry said upper surface a second time.

28. The method of claim 24 wherein said rinsing uses deionized H2O and said drying means is one of a blow dry, a spin dry and a combination thereof.

29. The method of claim 27 wherein said first rinsing uses deionized H₂O and said first drying means is one of a blow dry, a spin dry and a combination thereof; and said second rinse uses deionized H₂O, and said second drying means is one of a blow dry, a spin dry and a combination thereof.

30. the method of claim 24 further comprising the removal of the second constitution.

31. The method of claim 24 wherein the gaseous chemical compound interacts preferentially with said upper surface compared to the bulk.

32. the method of claims 24 wherein said bulk has a dielectric constant of at least about 20.

33. the method of claims 32 wherein the first constitution comprises a perovskite structure.

34. The method of claim 33 where perovskite structure comprises a composition having at least one member selected from the group consisting of barium, strontium and bismuth and at least one member selected from the group consisting of titanates, tantalates and niobates.

35. The method of claim 31 wherein said gas reactant comprises HF.

36. The method of claim 31 wherein said gas reactant comprises a mixture of HF and NH₃.

37. The method of claim 33 further comprising the step of heating the high dielectric constant material to at least 275 C. after interacting said upper surface with a gas reactant in a closed environment.

38. The method of claim 24 wherein the first constitution is silicon dioxide and the second constitution is silicon nitride.
